(19) United States
(12) Patent Application Publication
(10) Pub. No.: US 2008/0240519 A1
(43) Pub. Date: Oct. 2, 2008

(54) RECOGNITION DEVICE, RECOGNITION METHOD, AND COMPUTER-READABLE RECORDING MEDIUM RECORDED WITH RECOGNITION PROGRAM

(76) Inventor: Sachio NAGAMITSU, Kyoto (JP)

Correspondence Address: WENDEROTH, LIND & PONACK L.L.P., 2033 K. STREET, NW, SUITE 800, WASHINGTON, DC, 20006, US

(21) Appl. No.: 12/058,164

(22) Filed: Mar. 28, 2008

(30) Foreign Application Priority Data
Mar. 29, 2007 (JP) 2007-088654

(51) Int. Cl. G06K 9/00

(52) U.S. Cl. 382/118

(57) ABSTRACT

An object of the invention is to provide a user in performing a work with a proper advice and support the user's work. An advice database stores advice data for supporting a user in performing a work. An advice selector selects advice data in accordance with the user's work from the advice database. An advice presenter presents the user with the advice data selected by the advice selector. A user status recognizer recognizes a reaction of the user to the advice data presented by the advice presenter. A user dependence estimator estimates a dependence degree of the user indicating how much the user relies on the presented advice data, based on the user's reaction recognized by the user status recognizer. The advice selector selects advice data in accordance with the user's dependence degree estimated by the user dependence estimator from the advice database.

### BACKGROUND OF THE INVENTION

1. Field of the Invention

The present invention relates to a recognition device, a recognition method, and a computer-readable recording medium recorded with the recognition program for presenting a user with an advice for supporting the user in performing a work by using a text, an image, a sound, or a like tool.

2. Description of the Background Art

Heretofore, there has been proposed a display device (called as “first conventional art”) for changing the display contents in accordance with the proficiency of the user to support the user in performing an input operation with respect to an apparatus (see e.g. Japanese Unexamined Patent Publication No. 2000-066789 corresponding to U.S. Pat. No. 6,636,236B1). In the display device, a degree of unnecessity on display contents is estimated based on user's usage history information such as the number of times of starting up the apparatus, the number of times of displaying data, a time spent in key input operation, and a used storage capacity of the apparatus.

Also, there is known a work support system (called as “second conventional art”) configured in such a manner that an utterance of the user is recognized, while recognizing the current status of the user, a user's related utterance in response to guidance information is recognized in association with a previous system utterance or a previous user's utterance, information necessary for supporting the user's current work is retrieved from a database in accordance with the recognition results to guide the user with the retrieved necessary information (see e.g. Japanese Unexamined Patent Publication No. Hei 10-143187).

Further, an approach (called as “third conventional art”) is being studied concerning quantitatively measuring a change of interest in individual target objects in terms of an image in a condition that the user is allowed to choose a target object (see e.g. “Estimation of Human Interest Level in Choosing from Video Sequence” by Yusuke WAKAI, Kazuhiko SUMI, and Takashi MATSUYAMA). In this technology, a body image, a face image, and a line of sight are extracted based on a user's image captured by a camera disposed near the target object, and a change in degree of interest is extracted by recognizing a change of these parameters, utilizing a property that a human approaches and gazes at a target object, as his or her interest in the target object is increased.

The first conventional art is proposed on the premise that the user directly performs an input operation with respect to an apparatus. Accordingly, it is difficult to apply the technology to a case that the user indirectly performs an input operation with respect to an apparatus, without directly performing an input operation.

In the second conventional art, respective operation information are individually acquired, and the acquired operation information are individually compared with an ideal value.

Accordingly, the second conventional art is effective only in a specific operation whose information is stored in a database. Also, it is unclear whether an advice presented at a timing when the user has not decided what to do is appropriate.

In the third conventional art, multiple target objects are prepared. Accordingly, it is impossible to apply the third conventional art to a case that a single target object is prepared. Also, since the size of the face of a user detected by the camera is used, the third conventional art is applied merely to a case that the distance between the camera and the user is fixed. Thus, the third conventional art has poor versatility.

### SUMMARY OF THE INVENTION

In view of the above problems residing in the conventional examples, it is an object of the present invention to provide a recognition device, a recognition method, and a computer-readable recording medium recorded with the recognition program that enable to present a user in performing a work with a proper advice.

A recognition device according to an aspect of the invention comprises: an advice data storage for storing advice data for supporting a user in performing a work; an advice selector for selecting advice data for the work from the advice data storage; an advice presenter for presenting the user with the advice data selected by the advice selector; a user status recognizer for recognizing a reaction of the user to the advice data presented by the advice presenter; and a user dependence estimator for estimating a dependence degree of the user indicating how much the user relies on the advice data presented by the advice presenter, based on the user's reaction recognized by the user status recognizer, wherein the advice selector selects, from the advice data storage, the advice data in accordance with the user's dependence degree estimated by the user dependence estimator.

A recognition method according to another aspect of the invention comprises: an advice selecting step of selecting advice data for a work from an advice data storage for storing the advice data for supporting the user in performing the work; an advice presenting step of presenting the user with the advice data selected in the advice selecting step; a user status recognizing step of recognizing a reaction of the user to the advice data presented in the advice presenting step; and a user dependence estimating step of estimating a dependence degree of the user indicating how much the user relies on the advice data presented in the advice presenting step, based on the user's reaction recognized in the user status recognizing step, wherein, in the advice selecting step, the advice data in accordance with the user's dependence degree estimated in the user dependence estimating step is selected from the advice data storage.

A computer-readable recording medium recorded with a recognition program according to still another aspect of the invention causes a computer to function as: an advice data storage for storing advice data for supporting a user in performing a work; an advice selector for selecting advice data for the work from the advice data storage; an advice presenter for presenting the user with the advice data selected by the advice selector; a user status recognizer for recognizing a reaction of the user to the advice data presented by the advice presenter; and a user dependence estimator for estimating a dependence degree of the user indicating how much the user relies on the advice data presented by the advice presenter, based on the user's reaction recognized by the user status recognizer, wherein the advice selector selects, from the advice data storage, the advice data in accordance with the user's dependence degree estimated by the user dependence estimator.

In the above arrangements, the user's dependence degree indicating how much the user relies on the currently presented advice data is estimated, and the advice data in accordance with the estimated user's dependence degree is selected from the advice data storage. This enables to present the user in performing the work with a proper advice.

These and other objects, features and advantages of the present invention will become more apparent upon reading the following detailed description along with the accompanying drawings.

### BRIEF DESCRIPTION OF THE DRAWINGS

FIG. 1 is a block diagram showing an arrangement of a work support device embodying the invention.

FIG. 2 is a diagram for describing a positional arrangement of constituent elements of the work support device in the embodiment.

FIG. 3 is a graph for describing an operation to be performed by a user dependence estimator in the embodiment.

FIG. 4 is a graph showing a change in movements of the face and a line of sight of a user in the case where the contents of advice data is changed in the course of the user's work.

FIG. 5 is a flowchart for describing an operation to be performed by the work support device shown in FIG. 1.

FIG. 6 is a diagram showing an example of an advice screen image.

FIG. 7 is a flowchart for describing a user status recognizing operation in Step S5 in FIG. 5.

FIG. 8 is a graph showing experiment results, in which movements of the face and line of sight of twenty subjects are recognized in a condition that the subjects perform a mimicking cooking operation while being presented with advice data.

FIG. 9 is a graph showing experiment results, in which movements of the face and line of sight of eight subjects are recognized in a condition that the subjects perform an actual cooking operation while being presented with advice data.

FIG. 10 is a flowchart for describing a user dependence estimating operation in Step S8 in FIG. 5.

FIG. 11 is a flowchart for describing an advice data selecting operation in Step S3 in FIG. 5.

### DETAILED DESCRIPTION OF THE PREFERRED EMBODIMENTS OF THE INVENTION

In the following, an embodiment of the invention is described referring to the accompanying drawings. The following embodiment is merely an example embodying the invention, and does not limit the technical scope of the invention.

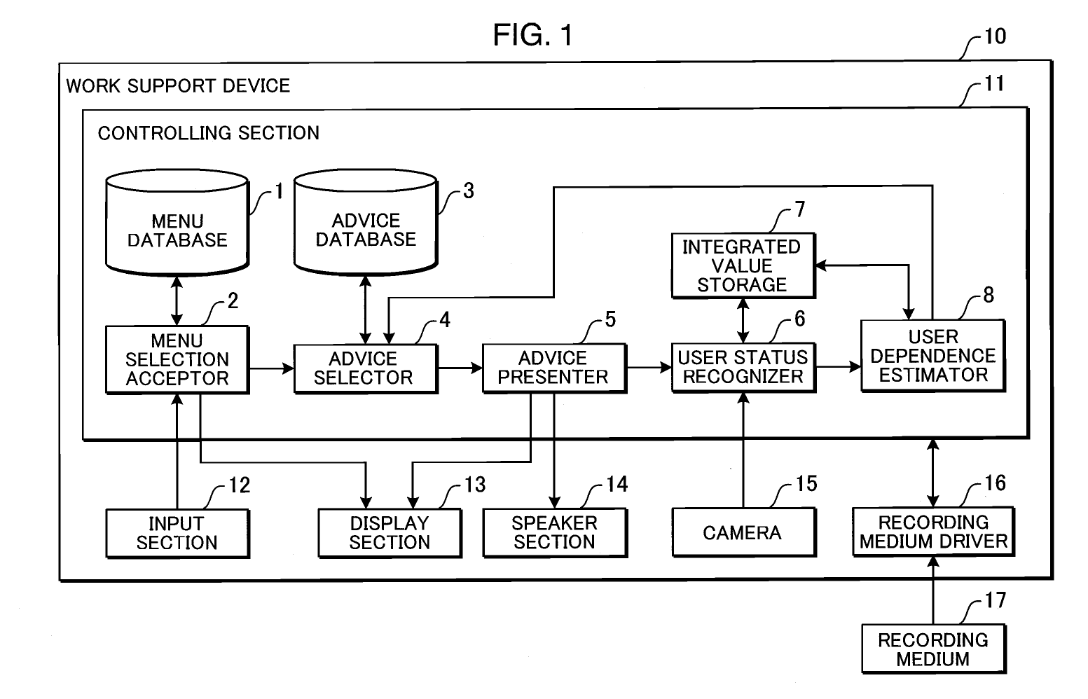

FIG. 1 is a block diagram showing an arrangement of a work support device embodying the invention. Referring to FIG. 1, the work support device 10 as a recognition device includes a controlling section 11, an input section 12, a display section 13, a speaker section 14, a camera 15, and a recording medium driver 16. In this embodiment, description is made primarily on supporting a user in performing a cooking operation as a work. The embodiment of the invention is not specifically limited to the above. For instance, the embodiment of the invention may be applicable to supporting a user in driving an automobile.

The controlling section 11 includes e.g. a CPU (Central Processing Unit), an RAM (Random Access Memory), and an ROM (Read Only Memory). The input section 12 is used for allowing the user to input various data, operation commands, and the like. The display section 13 displays multiple menus capable of presenting advices. The display section 13 also displays advice data for the user. The speaker section 14 outputs advice data for the user in terms of sounds. In this embodiment, the input section 12 and the display section 13 are individually provided. Alternatively, the input section 12 and the display section 13 may constitute a touch panel device or a like device.

The camera 15 is disposed at a position displaced by a certain degree with respect to a direction in which the user's face directs a target object (hereinafter, called as “work object”) for which the user executes his or her work to capture an image of the user. Specifically, the camera 15 includes e.g. a CCD area sensor to capture an image of the user including his or her face at a predetermined frame rate. The display section 13 and the speaker section 14 are disposed in the identical direction as the camera 15.

The recording medium driver 16 includes e.g. a DVD-ROM drive, a CD-ROM drive, or a flexible disk drive. A work support program as a recognition program may be recorded in a computer-readable recording medium 17 such as a DVD-ROM, a CD-ROM or a flexible disk so that the recording medium driver 16 is operative to read out the work support program from the recording medium 17 to install the work support program in an external storage device (not shown) for execution. In the case where the work support device 10 includes a communications device, and the work support program is stored in a computer connected to the work support device 10 via a communications network, the work support program may be downloaded from the computer via the network for execution.

The arrangement of the controlling section 11 is described in the following. The controlling section 11 includes a menu database 1, a menu selection acceptor 2, an advice database 3, an advice selector 4, an advice presenter 5, a user status recognizer 6, an integrated value storage 7, and a user dependence estimator 8.

The menu database 1 stores multiple menus capable of providing the user with various advices. In the case where the user performs a cooking operation, the menu indicates work contents, specifically, the name of a cuisine. The menu selection acceptor 2 accepts selection of a menu for which the user wishes to obtain an advice, from the multiple menus. Specifically, the menu selection acceptor 2 displays the multiple menus stored in the menu database 1 on the display section 13, and accepts use's selection of one menu from the multiple menus through the input section 12.

The advice database 3 stores advice data effective in supporting the user in performing his or her work, and stores contents including moving images, sounds, still images, or characters/symbols, as a visual advice or an audio advice. The advice data is attached with an attribute to perform classification concerning the proficiency i.e. the skill level of the user with respect to the work in this embodiment. In other words, multiple advice data are stored depending on the skill levels, as advices for an identical menu.

In this embodiment, the advice database 3 stores advice data for supporting the user in performing a cooking operation. Alternatively, in the case where user's driving operation of an automobile is supported, the advice database 3 stores advice data for supporting the user in driving an automobile.

The advice selector 4 selects advice data corresponding to a work from the advice database 3. The advice selector 4 selects, from the advice database 3, advice data in accordance with the menu accepted by the menu selection acceptor 2. The criteria on selection of advice data by the advice selector 4 will be described later.

The advice presenter 5 presents the user with the advice data selected by the advice selector 4. The method for presenting advice data differs depending on a user's degree of dependence on an advice. The advice data may be presented by using the display section 13, the speaker section 14, or a like device, singly or in combination, according to needs.

The user status recognizer 6 recognizes a user's reaction to the advice data presented by the advice presenter 5. Specifically, the user status recognizer 6 recognizes a change in user's body reaction with time to the advice data presented by the advice presenter 5.

In this embodiment, the camera 15 is used to recognize the user's status. The user status recognizer 6 recognizes a movement of the user's face based on an image captured by the camera 15, and integrates a duration when the user's face is inclined with respect to a condition that the user's face directs the work object in forward direction toward the display section 13 by a predetermined angle.

More specifically, the user status recognizer 6 recognizes a movement of the user's face based on an image captured by the camera 15, integrates a first duration when the user's face directs the display section 13 in forward direction, and integrates a second duration when the user's face is inclined toward the display section 13 with respect to a condition that the user's face directs the work object in forward direction by an angle smaller than the angle defined by the direction in which the user's face directs the work object in forward direction, and the direction in which the user's face directs the display section 13 in forward direction. The user status recognizer 6 also recognizes a movement of the user's line of sight based on the image captured by the camera 15, and integrates the number of times by which the duration when the user's line of sight is aligned with the direction of the display section 13 is shorter than a predetermined duration.

In this embodiment, the user status recognizer 6 may recognize a condition that the user's line of sight is substantially aligned with the direction of the display section 13, in place of the condition that the user's line of sight is completely aligned with the direction of the display section 13; and the number of times by which the duration when the user's line of sight is substantially aligned with the direction of the display section 13 is shorter than a predetermined duration may be integrated.

The integrated value storage 7 includes an electrically rewritable nonvolatile memory such as an EEPROM, and stores an integrated value of the first duration when the user's face directs the display section 13 in forward direction; an integrated value of the second duration when the user's face is inclined toward the display section 13 with respect to a condition that the user's face directs the work object in forward direction by an angle smaller than the angle defined by the direction in which the user's face directs the work object in forward direction, and the direction in which the user's face directs the display section 13 in forward direction; and an integrated value of the number of times by which the duration when the user's line of sight is aligned with the direction of the display section 13 is shorter than the predetermined duration.

The user dependence estimator 8 estimates a user's dependence degree on advice data, based on a user's reaction recognized by the user status recognizer 6. Specifically, the user dependence estimator 8 estimates whether the user's dependence degree on the currently presented advice data has increased or decreased, based on the first duration, the second duration, and the number of times integrated by the user status recognizer 6. The user's dependence degree indicates how much the user uses the work support device.

More specifically, in the case where the first duration integrated during a predetermined current measuring period is larger than the first duration integrated during a predetermined last measuring period, the user dependence estimator 8 estimates that the user's dependence degree has increased. In the case where the first duration integrated during the predetermined current measuring period is not larger than the first duration integrated in the predetermined last measuring period, and the second duration integrated during the predetermined current measuring period is larger than the second duration integrated during the predetermined last measuring period, the user dependence estimator 8 estimates that the user's dependence degree has lowered to a first stage.

In the case where the first duration integrated during the predetermined current measuring period is not larger than the first duration integrated during the predetermined last measuring period, the second duration integrated during the predetermined current measuring period is not larger than the second duration integrated during the predetermined last measuring period, and the number of times integrated during the predetermined current measuring period is larger than the number of times integrated during the predetermined last measuring period, the user dependence estimator 8 estimates that the user's dependence degree has lowered to a second stage lower than the first stage.

In the case where the number of times integrated during the predetermined last measuring period is larger than the number of times integrated during a predetermined second from the last measuring period, and the number of times integrated during the predetermined current measuring period is not larger than the number of times integrated during the predetermined last measuring period, the user dependence estimator 8 estimates that the user's dependence degree has lowered to a third stage lower than the second stage.

The advice selector 4 selects, from the advice database 3, advice data in accordance with the user's dependence degree estimated by the user dependence estimator 8. For instance, the advice selector 4 selects advice data by correlating a user's dependence degree to a degree of skill level. Specifically, in the case where the user's dependence degree on the presented advice data is estimated to be high, it is generally conceived that the user's skill of the work is low. Accordingly, in the case where the user's dependence degree is estimated to be high, it is appropriate to provide advice data whose skill level is lower than the skill level of the currently presented advice data, or equal to the skill level of the currently presented advice data. Conversely, in the case where the user's dependence degree is estimated to be low, it is generally conceived that the user's skill is high. Accordingly, in the case where the user's dependence degree is estimated to be low, it is appropriate to provide advice data whose skill level is higher than the skill level of the currently presented advice data.

More specifically, the advice database 3 stores advice data in accordance with each of multiple stages i.e. the first stage, the second stage, and the third stage estimated by the user dependence estimator 8. In the case where the user dependence estimator 8 estimates that the user's dependence degree has lowered to the first stage, the advice selector 4 selects advice data corresponding to the first stage from the advice database 3. In the case where the user dependence estimator 8 estimates that the user's dependence degree has lowered to the second stage, the advice selector 4 selects advice data corresponding to the second stage from the advice database 3. In the case where the user dependence estimator 8 estimates that the user's dependence degree has lowered to the third stage, the advice selector 4 selects advice data corresponding to the third stage from the advice database 3.

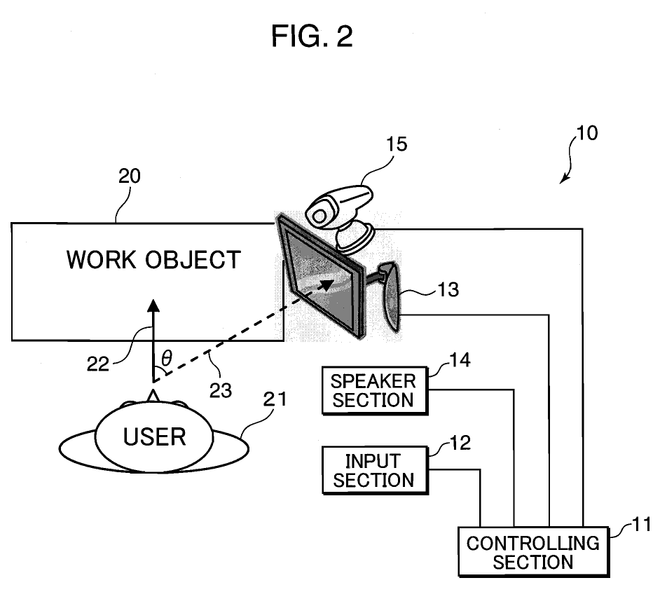

In the following, a positional arrangement of the constituent elements of the work support device 10 in the embodiment is described referring to FIG. 2. FIG. 2 is a diagram for describing the positional arrangement of the constituent elements of the work support device 10 in the embodiment.

In this embodiment, a user 21 performs his or her work, as opposed to a work object 20. The work to be performed in this embodiment is a cooking operation. The display section 13 is disposed in juxtaposition to the work object 20. In this embodiment, the display section 13 is disposed at a position where the angle defined by the direction 22 in which the face of the user 21 directs the work object 20 in forward direction, and the direction 23 in which the face of the user 21 directs the display section 13 in forward direction is set to 30 degrees. The camera 15 is disposed in proximity to an upper portion of the display section 13.

In the above arrangement, when the user 21 executes an ordinary work, the user 21 continues the work, with his or her head and line of sight being aligned in the direction of the work object 20. The display section 13 displays advice data including recipe information and cooking utensil information for supporting the user 21 in performing a cooking operation at a predetermined timing. The advice data is basically provided by way of moving images and character information, but may include e.g. audio information, corresponding to character information, to be outputted as sounds to alert the user 21 of presentation of advice data. As advice data is presented, the user 21 may look at the direction of the display section 13 during his or her work. The timing when the user 21 looks at the display section 13 includes the timing of presenting the user 21 with advice data. The camera 15 continuously captures movements of the user's head and line of sight.

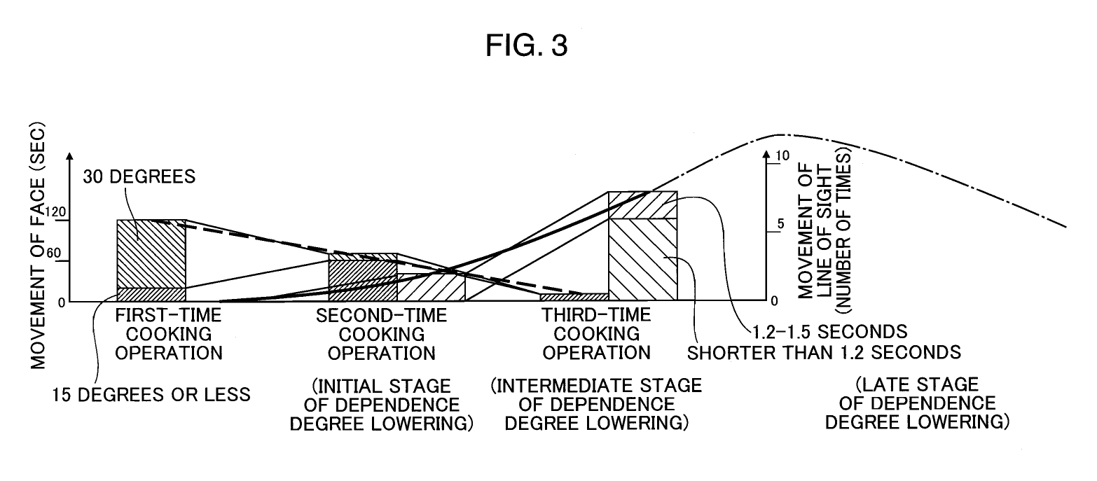

In the following, an operation to be performed by the user dependence estimator 8 for estimating a user's dependence degree is described referring to FIG. 3. FIG. 3 is a graph for describing an operation to be performed by the user dependence estimator 8. The left-side vertical axis in the bar graph of FIG. 3 indicates an integrated value of a duration when the user's face or head is inclined by 30 degrees, and 15 degrees or less, in the case where the movement of the user's face or head during an advice presentation period is classified into a condition that an inclination angle θ of the user's head is 30 degrees, and a condition that the inclination angle θ of the user's head is 15 degrees or less. The right-side vertical axis in FIG. 3 indicates an integrated value of the number of times by which a duration when the user's line of sight is aligned with the direction of the display section 13 is not shorter than 1.2 seconds and not longer than 1.5 seconds, and shorter than 1.2 seconds, in the case where the movement of the user's line of sight during the advice presentation period is classified into a condition that the duration when the user's line of sight is aligned with the direction of the display section 13 is not shorter than 1.2 seconds and not longer than 1.5 seconds, and a condition that the duration when the user's line of sight is aligned with the direction of the display section 13 is shorter than 1.2 seconds. The horizontal axis in FIG. 3 indicates the number of times when the user 21 performs a cooking operation. In this embodiment, an experiment result is shown, wherein an identical user has performed a cooking operation three times. In each of the cooking operations, two bar graphs are plotted, wherein the left-side bar graph indicates a movement of the user's face, and the right-side bar graph indicates a movement of the user's line of sight.

Detailed description on the above movements is made referring to FIG. 3 as follows. At first, the user status recognizer 6 determines a movement of the user's head by the orientation of a user's face image captured by the camera 15. The camera 15 captures an image of the user 21 in an obliquely forward direction. In the case where the user 21 directs the work object 20, the user status recognizer 6 is allowed to specify the direction in which the user 21 directs, based on a relative position of the camera 15 to the work object 20. Since the camera 15 is arranged above the display section 13, the camera 15 is allowed to determine in which direction the user 21 directs with respect to the display section 13. A number of methods have been developed to estimate the orientation of a human face based on a captured image. Accordingly, it is easy to judge whether the inclination angle θ of the user's head is equal to 15 degrees or less, and real-time processing is possible.

In the experiment, in the case where the inclination angle θ of the user's face is larger than 15 degrees and not larger than 30 degrees, it is determined that the user 21 looks at the screen of the display section 13 in forward direction.

The movement of the user's line of sight is captured simultaneously with the movement of the user's face. In other words, image data used in recognizing the movement of the user's face is also used in recognizing the movement of the user's line of sight. In recent years, a number of methods and devices have been developed concerning a movement of a line of sight, and it is easy to measure a movement of a line of sight in the order of one-tenth second. A status on a line of sight can be classified into a target object search status, and a detailed information acquisition status. When the line of sight is in the former status, a subject finds a certain object of interest, and his or her line of sight stays in a substantially fixed area for a period not shorter than 1.2 seconds and not longer than 1.5 seconds. On the other hand, when the line of sight in the latter status, if the line-of-sight stay duration is shorter than 1.2 seconds, it is reportedly impossible to confirm whether the subject has a keen interest in an object despite that his or her line of sight stays in a certain fixed area. In view of the above, the experiment in this embodiment was separately conducted in a condition that a subject looked at the display section 13 for a duration shorter than 1.2 seconds, and a condition that the subject looked at the display section 13 for a duration not shorter than 1.2 seconds and not longer than 1.5 seconds, and the integrated value of the number of times concerning these two conditions was calculated separately.

In this embodiment, the duration when the user looks at the display section 13 is classified into two kinds: one is the line-of-sight stay duration shorter than 1.2 seconds, and the other is the line-of-sight stay duration not shorter than 1.2 seconds and not longer than 1.5 seconds. However, in a final judgment, the user's dependence degree is evaluated based on the former line-of-sight stay duration of shorter than 1.2 seconds. In this embodiment, the value of 1.2 seconds is adopted because a time zone indicating that the user “looks at an object for a short time just for checking” is utilized, unlike the conventional art wherein a judgment as to whether a subject has an interest in an object is performed.

In other words, the above value is not specifically limited, but may be flexibly changed with a certain range, because the line-of-sight stay duration changes depending on the quantity and the quality of the contents of an advice screen as an application software. Substantially the same effect as described above can be obtained by using the value of 1.5 seconds, in place of 1.2 seconds. This can be presumed because a difference in duration between 1.2 seconds and 1.5 seconds is significantly small. Actually, a change was verified by using a value of shorter than 1.0 second. Substantially the same tendency is obtained as in the case that the value of 1.2 seconds is used. In other words, a value smaller than 1.2 seconds, or a value larger than 1.5 seconds may be used depending on an advice screen presentation, and substantially the same effect as in the case of using the value of 1.2 seconds is obtained.

The user's dependence degree on advice data can be estimated by using the movement of the user's face or head, and the movement of the user's line of sight. FIG. 3 shows a result of an experiment that a cooking operation was performed three times, wherein identical advice data corresponding to identical recipe information was used throughout the three-times cooking operations. The cooking operation includes a number of cooking steps. Accordingly, the advice database 3 stores multiple advice data corresponding to the cooking steps. The timing of updating the advice data is the point of time after completion of each of the cooking steps, and before a succeeding cooking step is started. Moving image information and character information on the contents of the succeeding cooking step were presented as advice data. Simultaneously, a part of the character information was reproduced as synthesized sounds at the time of updating the advice data to alert the user 21 concentrating in the work that the advice data has been updated. In the experiment, the user 21 has cooking experience, but does not have cooking experience on the recipe presented in the experiment.

The first-time cooking operation was carried out by referring to advice information displayed on the display section 13. In particular, a user's cooking status indicating that the user's face movement was active, and the user 21 gazed at the display section 13 with the inclination angle θ of 30 degrees and positively utilized advice data was quantitatively measured. Although the user's face movement corresponding to the inclination angle θ of 15 degrees or less has appeared, most of the movement indicates that the user 21 looked at the display section 13, expecting advice data to be presented, despite that the advice data had not been updated. This means that the user 21 pays his or her attention to the display section 13. On the other hand, the movement of the user's line of sight is zero on the bar graph, because the duration when the user 21 gazed at the advice data displayed on the display section 13 was 1.5 seconds or longer.

In the second-time cooking operation, since the user 21 was familiar with the recipe, the frequency of looking at the display section 13 in forward direction was rapidly lowered, and a movement corresponding to the inclination angle θ of 15 degrees or less, which indicated expectation for advice data, has significantly increased. On the other hand, concerning a movement of the line of sight, the number of times by which the duration when the user 21 gazed at the advice data displayed on the display section 13 was not shorter than 1.2 seconds and not longer than 1.5 seconds appeared. This shows user's expectation for updating the advice data.

As shown in FIG. 3, in the second-time cooking operation, the frequency of the movement of the user's face corresponding to the inclination angle of 15 degrees or less, and the frequency of the movement of the user's line of sight corresponding to the line-of-sight stay duration of not shorter than 1.2 seconds and not longer than 1.5 seconds increased. This means that the user's dependence degree on advice data has lowered. A result of interview with the user 21 conducted after the experiment shows that in the first-time cooking operation, the user 21 utilized all the character information including a part of the character information which was reproduced as synthesized sounds, as well as advice data as moving images; but in the second-time cooking operation, in most of the time, the user 21 paid his or her attention to the character information which was reproduced as synthesized sounds just to make sure whether the contents of advice data was updated.

In the third-time cooking operation, the movement of the user's face was seldom observed, and the number of times by which the advice data gazing duration was shorter than 1.2 seconds was rapidly increased. This means that the cooking status of the user 21 indicating that the user's line of sight directs toward the display section 13 without moving the face is quantitatively measured. A result of interview with the user 21 conducted after the experiment shows that the user 21 was sometimes tempted to look at the display section 13 to confirm whether the contents of advice data was the same as the previous one, because synthesized sounds were outputted. As shown in FIG. 3, in the third-time cooking operation, although the user's expectation for advice data was continued, it can be concluded that the user 21 substantially does not rely on advice data.

In the case where identical advice data is presented a number of times, as shown by the one-dotted-chain line in FIG. 3, it is estimated that the sum of the number of times by which the advice data gazing duration is shorter than 1.2 seconds, and the number of times when the advice data gazing duration is not shorter than 1.2 seconds and not longer than 1.5 seconds is increased, as the number of times of cooking operations is incremented, and then decreased. This is because the user has learned that the contents of advice data is the same as the previous one, and the user's dependence degree on advice data has lowered.

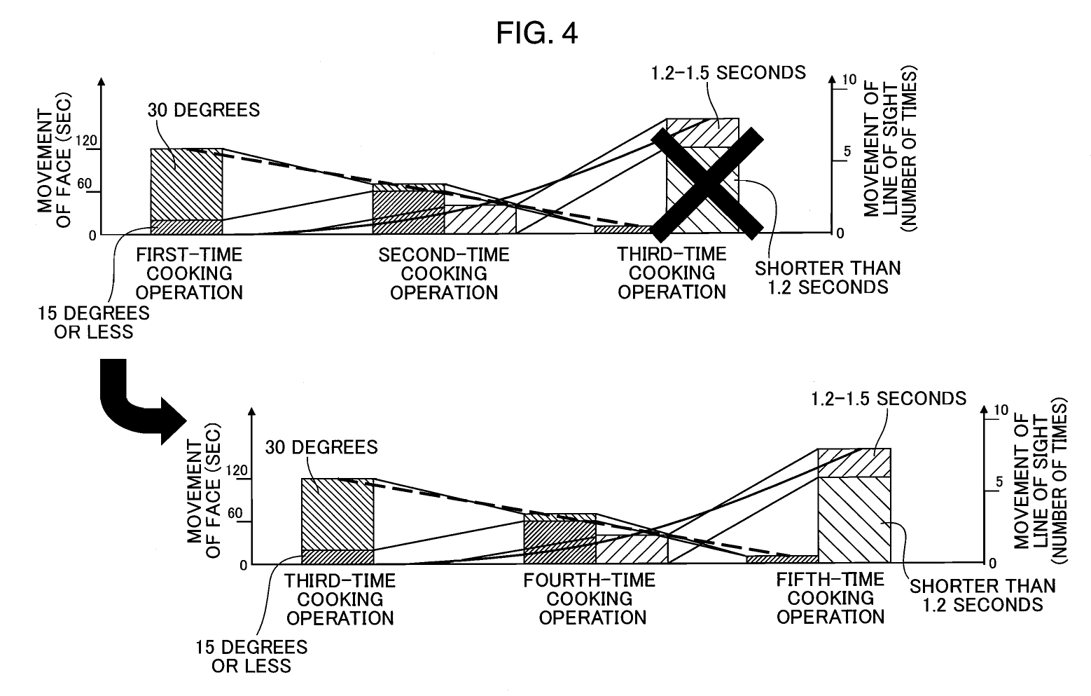

In the following, a change in the user's dependence degree, resulting from changing the presentation contents of advice data is described referring to FIG. 4. FIG. 4 is a graph showing a change in movements of the user's face and line of sight in the case where the contents of advice data is changed in the course of the user's work. In this embodiment, an experiment was conducted aiming at increasing the dependence degree of the user 21 on advice data by updating the contents of advice data, as the user's dependence degree is lowered. In other words, in this embodiment, an experiment was conducted not only to estimate the user's dependence degree but also to encourage the user to continuously utilize advice data by increasing a lowered dependence degree in the aspect of practical use of the work support device.

Referring to FIG. 4, a third-time cooking operation was conducted by updating the contents of advice data based on the result of the second-time cooking operation, in place of letting the user perform the third-time cooking operation with the same advice data contents as in the second-time cooking operation. Although the updated advice data contents was differentiated depending on the cooking step, the skill level was increased concerning presentation of moving image information and character information. Among the character information to be displayed, character information to be outputted as synthesized sounds remained unchanged to alert the user 21 of the timing of presenting advice data.

FIG. 4 shows the movements of the user's face and line of sight in the first-time through the fifth-time cooking operations in bar graphs in the case where the advice data contents was updated at the third-time cooking operation. As a result of updating the advice data contents, the dependence degree of the user 21 on advice data was increased from a considerably lowered state at the third-time cooking operation, and the increased user's dependence degree on advice data was substantially held until the fifth-time cooking operation.

In this embodiment, the user 21 directs the work object 20 in forward direction. In an actual work, however, the user 21 may move within a certain area including an occasion that the user 21 performs a cooking operation. In such an occasion, it is not always the case that the angle defined by the direction in which the user's face directs the work object in forward direction, and the direction in which the user's face directs the display section 13 in forward direction is set to 30 degrees. The user's dependence degree can be estimated by the same approach as described above, and the inclination angle θ may be variable.

In view of the above, the direction of the camera 15 disposed above the display section 13 should follow the movement of the user 21, or a wide-angle camera lens may be used to capture an image of the user 21 who may move from time to time during his or her work.

The attribute of advice data stored in the advice database 3 not only includes the skill level but also includes an estimated total cooking time, the ratio of healthy ingredients to be used in cooking, or the like. Further, the attribute of advice data may include a speed of displaying moving images, the size of characters, or the expression of text, depending on the attribute i.e. the age of the user 21. For instance, the advice database 3 may store, as advice data for elderly persons or children, advice data configured in such a manner that the speed of displaying moving images is lowered, the size of characters is increased, or the expression of text is easily understandable.

The advice database 3 stores advice data in accordance with the kind of work and the attribute. The kind of cooking operation includes e.g. menus i.e. recipes, Japanese/Asian food, Western food, breakfast, lunch, supper, dietary food, nutrition oriented food, and desserts. The kind of driving operation includes e.g. display of route, display of mileage, display of traffic information, display of scenic location, display of gas filling station, and display of restaurant. The attribute of cooking operation includes skill level i.e. proficiency, degree of urgency, favor of taste (sweet or hot), and nutrition balance. The attribute of driving operation includes skill level i.e. proficiency, shortcut, degree of safety, degree of energy saving, landscape, and convenience.

In this embodiment, the user dependence estimator 8 may estimate the user's dependence degree merely with use of a movement of the user's face. Specifically, in the case where the integrated value of a duration when the user's face is inclined toward the display section 13 with respect to a condition that the user's face directs the work object 20 in forward direction is decreased, in other words, the integrated value of a duration when the inclination angle θ is 30 degrees, and the integrated value of a duration when the inclination angle θ is 15 degrees or less are decreased, the user dependence estimator 8 estimates that the user's dependence degree on the currently presented advice data has lowered.

In this embodiment, the user dependence estimator 8 may estimate the user's dependence degree merely with use of a movement of the user's line of sight. Specifically, in the case where the integrated value of the number of times by which a duration when the user's line of sight is aligned with the direction of the display section 13 is shorter than the predetermined duration is increased, in other words, the integrated value of the number of times by which a duration when the user's line of sight is aligned with the direction of the display section 13 is shorter than 1.2 seconds, and the integrated value of the number of times by which a duration when the user's line of sight is aligned with the direction of the display section 13 is not shorter than 1.2 seconds and not longer than 1.5 seconds are increased, the user dependence estimator 8 estimates that the user's dependence degree on the currently presented advice data has lowered.

In this embodiment, the user dependence estimator 8 may estimate the user's dependence degree with use of both of the movements of the user's face and line of sight. Specifically, in the case where the integrated value of a duration when the user's face is inclined toward the display section 13 with respect to a condition that the user's face directs the work object 20 in forward direction is decreased, and the integrated value of the number of times by which a duration when the user's line of sight is aligned with the direction of the display section 13 is shorter than the predetermined duration is increased, the user dependence estimator 8 estimates that the user's dependence degree on the currently presented advice data has lowered.

Substantially the same effect is obtained in any of the case that the user's dependence degree is estimated merely with use of the movement of the user's face; the use's dependence degree is estimated merely with use of the movement of the user's line of sight; and the user's dependence degree is estimated with both of the movements of the user's face and line of sight.

The user status recognizer 6 may recognize that the user has slightly inclined his or her head, shook his or her head, or the user's face is emotionless by analyzing a photographic image of the user 21 captured by the camera 15. In the case where any of the above statuses of the user 21 has been recognized, the user dependence estimator 8 may estimate that the user 21 does not rely on advice data, and the user's dependence degree has lowered. Alternatively, the user status recognizer 6 may analyze audio information acquired through an unillustrated microphone to recognize an utterance of the user 21 indicating that the user 21 does not rely on advice data. If the user status recognizer 6 recognized the user's utterance indicating that the user 21 does not rely on advice data, the user dependence estimator 8 may estimate that the user 21 does not rely on advice data, and the user's dependence degree has lowered.

The user status recognizer 6 may judge whether the user 21 is operating the apparatus according to the advice by analyzing a photographic image of the user 21 captured by the camera 15, and analyzing apparatus operation information indicating an operating status of the apparatus by the user 21. In the case where it is judged that the apparatus is operated according to the advice, the user dependence estimator 8 may estimate that the user 21 relies on advice data, and the user's dependence degree is high. In the case where it is judged that the apparatus is not operated according to the advice, the user dependence estimator 8 may estimate that the user 21 does not rely on advice data, and the user's dependence degree has lowered.

Alternatively, the user status recognizer 6 may acquire, from the apparatus, apparatus operation information indicating an operating status of the apparatus by the user, analyze the acquired apparatus operation information, and judge whether the apparatus is operated according to the advice. In the case where it is judged that the apparatus is operated according to the advice, the user dependence estimator 8 may estimate that the user 21 relies on advice data, and the user's dependence degree on advice data is high. In the case where it is judged that the apparatus is not operated according to the advice, the user dependence estimator 8 may estimate that the user 21 does not rely on advice data, and the user's dependence degree on advice data has lowered.

In the above methods, a fine technique is required to recognize a gesture or utterance contents which greatly differs among the individuals, such as a slight tilting of the user's head or an utterance indicating that the user 21 does not rely on advice data. Accordingly, it is necessary to discern in detail whether the apparatus is operated according to the advice, or pay attention to the arranged position of the camera 15, the number of cameras, or a like condition. On the other hand, the embodiment is advantageous in recognizing the user's status merely with use of the camera 15 disposed above the display section 13 by capturing an image of the user 21 during the advice data presentation period.

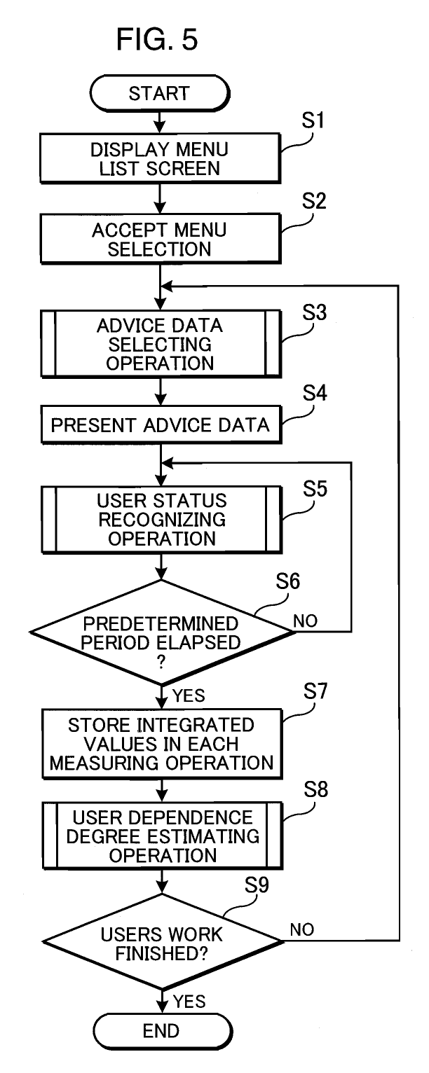

In the following, a detailed operation to be performed by the work support device of the embodiment is described. FIG. 5 is a flowchart for describing the operation to be performed by the work support device shown in FIG. 1.

First, in Step S1, the menu selection acceptor 2 reads out, from the menu database 1, multiple menus pre-stored therein, creates a menu list screen, and displays the created menu list screen on the display section 13.

Then, in Step S2, the menu selection acceptor 2 accepts one menu from the multiple menus. The user selects a menus for which he or she wishes to obtain an advice from the menu list screen displayed on the display section 13, using the input section 12.

Then, in Step S3, the advice selector 4 executes an advice data selecting operation. The advice data selecting operation will be described later in detail. The advice selector 4 selects, from the advice database 3, predetermined advice data corresponding to the menu accepted by the menu selection acceptor 2.

Then, in Step S4, the advice presenter 5 presents the advice data selected by the advice selector 4. Specifically, the advice presenter 5 controls the display section 13 to display an advice screen constituted of moving image information and character information, and controls the speaker section 14 to output audio information.

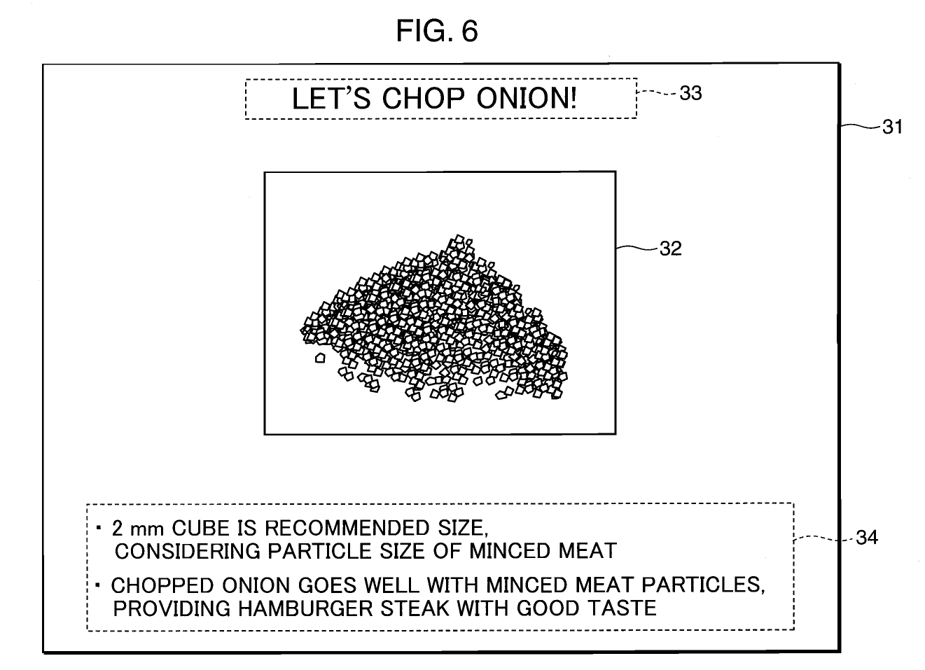

In this section, an advice screen is described. FIG. 6 is a diagram showing an example of the advice screen. The advice screen 31 includes an image display area 32 for displaying moving image information, and character display areas 33 and 34 for displaying character information. The image display area 32 is located in the middle of the advice screen 31 to display a moving image representing a cooking step for which an advice is currently presented. The character display area 33 is located in an upper part of the advice screen 31 to display a text describing an outline of the cooking step for which an advice is currently presented. The character display area 34 is located in a lower part of the advice screen 31 to display an advice message describing detailed contents of the cooking step for which an advice is currently presented.

A number of advice screens 31 are prepared in correspondence to the cooking steps. The advice presenter 5 controls the display section 13 to change over between the advice screens according to the cooking steps to sequentially display the advice screens. The advice presenter 5 controls the speaker section 14 to present the text displayed on the character display area 33 by way of sounds at a timing of changing over the advice screens. Thereby, the user is notified that the advice screen displayed on the display section 13 has changed.

On the character display area 34, there is displayed basic information on the cooking step for which an advice is currently presented, in other words, useful information for a less-skilled user. For instance, whereas character information is displayed on the character display area 34 for a less skilled user, character information is not displayed on the character display area 34 for a skilled user. This enables to present the user with advice data in accordance with the proficiency of the user.

In this embodiment, a moving image is displayed on the image display area 32. Alternatively, a still image may be displayed on the image display area 32. Further alternatively, solely a moving image or solely a still image may be displayed, or merely characters may be displayed on the advice screen 31.

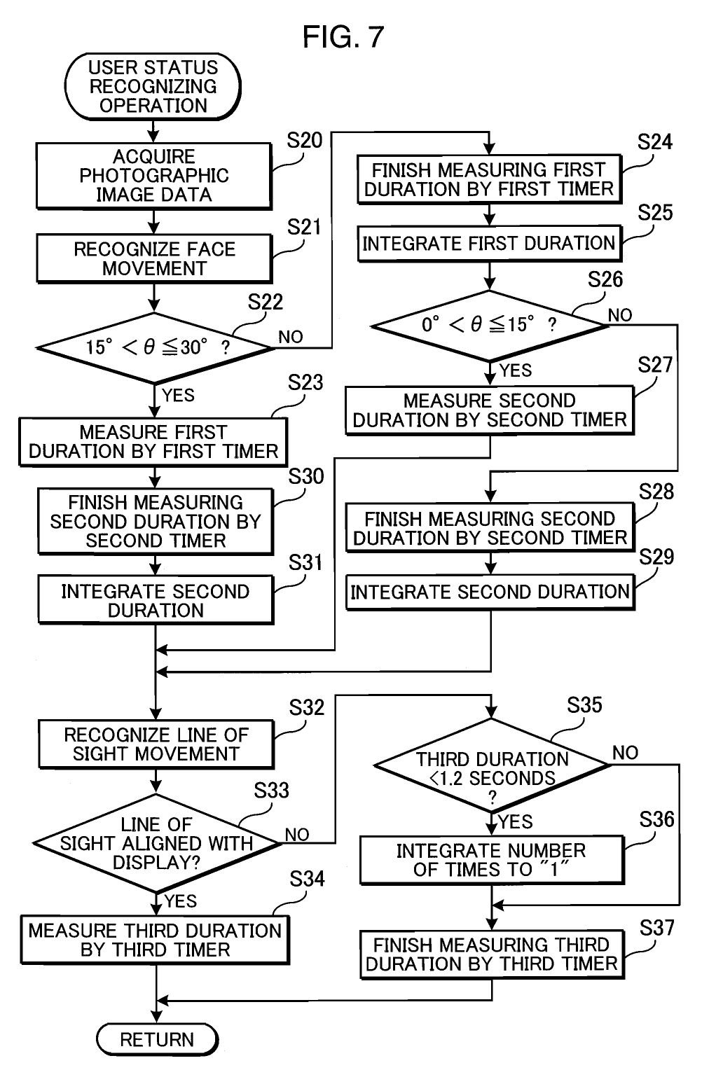

Subsequently, in Step S5, the user status recognizer 6 executes a user status recognizing operation. In this section, the user status recognizing operation is described in detail. FIG. 7 is a flowchart for describing the user status recognizing operation in Step S5 in FIG. 5.

When the user status recognizing operation is started, in Step S20, first, the user status recognizer 6 acquires photographic image data captured by the camera 15. Then, in Step S21, the user status recognizer 6 recognizes a movement of the user's face based on the photographic image data acquired by the camera 15. Specifically, the user status recognizer 6 detects the inclination angle θ of the user's face toward the display section 13 or the camera 15 with respect to a condition that the user's face directs the work object 20 in forward direction.

Then, in Step S22, the user status recognizer 6 judges whether the inclination angle θ of the user's face toward the display section 13 with respect to a condition that the user's face directs the work object 20 in forward direction is larger than 15 degrees and not larger than 30 degrees. If it is judged that the inclination angle θ is larger than 15 degrees and not larger than 30 degrees (YES in Step S22), in Step S23, the user status recognizer 6 starts measuring a duration by a first timer. The first timer measures the duration (hereinafter, called as “first duration”) when the inclination angle θ of the user's face is larger than 15 degrees and not larger than 30 degrees. In the case where the first timer has already started measuring the first duration, the first timer continues measuring the duration.

In the embodiment, the user status recognizer 6 judges whether the inclination angle θ of the user's face is larger than 15 degrees and not larger than 30 degrees. Alternatively, the user status recognizer 6 may judge whether the inclination angle θ of the user's face is 30 degrees.

If, on the other hand, the inclination angle θ of the user's face is not larger than 15 degrees or larger than 30 degrees (NO in Step S22), in Step S24, the user status recognizer 6 terminates the measuring operation by the first timer. Then, in Step S25, the user status recognizer 6 integrates the first duration measured by the first timer, and stores the integration result in the RAM. The user status recognizer 6 also integrates a duration when the user's face is inclined toward the display section 13 by a degree larger than 15 degrees and not larger than 30 degrees, and stores the integration result in the RAM. Then, the user status recognizer 6 sets the timer value of the first timer to “01”.

The operations in Step S24 and S25 are operations to be performed in the case where the first timer measures the first duration. Specifically, the operations in Step S24 and S25 are performed in the case where the inclination angle θ of the user's face is not larger than 15 degrees or larger than 30 degrees during a measuring operation of the first duration. In the case where a measuring operation is not performed by the first timer, the routine goes to Step S26 by skipping Step S24 and S25.

Then, in Step S26, the user status recognizer 6 judges whether the inclination angle θ of the user's face toward the display section 13 with respect to a condition that the user's face directs the work object 20 in forward direction is larger than 0 degree and not larger than 15 degrees. If the inclination angle θ is judged to be larger than 0 degree and not larger than 15 degrees (YES in Step S26), in Step S27, the user status recognizer 6 starts measuring a duration by a second timer. The second timer measures the duration (hereinafter, called as “second duration”) when the inclination angle θ of the user's face is larger than 0 degree and not larger than 15 degrees. In the case where the second timer has already started measuring the second duration, the second timer continues measuring the duration.

If, on the other hand, it is judged that the inclination angle θ is larger than 0 degree and not larger than 15 degrees (NO in Step S26), in Step S28, the user status recognizer 6 terminates the measuring operation by the second timer. Then, in Step S29, the user status recognizer 6 integrates the second duration measured by the second timer, and stores the integration result in the RAM. The user status recognizer 6 also integrates a duration when the user's face is inclined toward the display section 13 by a degree larger than 0 degree and not larger than 15 degrees, and stores the integration result in the RAM. Then, the user status recognizer 6 sets the timer value of the second timer to “0”. The area in the RAM where the integrated value of the second duration is stored is different from the area in the RAM where the integrated value of the first duration is stored. In view of this, the integrated value of the first duration and the integrated value of the second duration are individually stored.

The operations in Step S28 and S29 are operations to be performed in the case where the second timer measures the second duration. Specifically, the operations in Step S28 and S29 are performed in the case where the inclination angle θ of the user's face is not larger than 0 degree or larger than 30 degrees during a measuring operation of the second duration. In the case where a measuring operation is not performed by the second timer, the routine goes to Step S32 by skipping Step S28 and S29.

Then, in Step S30, the user status recognizer 6 terminates the measuring operation by the second timer. Then, in Step S31, the user status recognizer 6 integrates the second duration measured by the second timer, and stores the integration result in the RAM. Then, the user status recognizer 6 sets the timer value of the second timer to “0”.

The operations in Step S30 and S31 are operations to be performed in the case where the second timer measures the second duration. Specifically, the operations in Step S30 and S31 are performed in the case where the inclination angle θ of the user's face is larger than 15 degrees and not larger than 30 degrees during a measuring operation of the second duration. In the case where a measuring operation is not performed by the second timer, the routine goes to Step S32 by skipping Step S30 and S31.

Then, in Step S32, the user status recognizer 6 recognizes a movement of the user's line of sight based on the acquired photographic image data. Specifically, the user status recognizer 6 judges whether the user's line of sight is aligned with the direction of the display section 13 or the camera 15. In the case where the user 21 looks at the display section 13, the user's line of sight is aligned with the direction of the display section 13 or the camera 15.

Then, in Step S33, the user status recognizer 6 judges whether the user's line of sight is aligned with the direction of the display section 13. In the case where the user's line of sight is aligned with the direction of the display section 13 (YES in Step S33), in Step S34, the user status recognizer 6 starts measuring a duration by a third timer. The third timer measures the duration (hereinafter, called as a “third duration”) when the user's line of sight is aligned with the direction of the display section 13. In the case where the third timer has already started measuring the third duration, the third timer continues measuring the duration.

If, on the other hand, it is judged that the user's line of sight is not aligned with the direction of the display section 13 (NO in Step S33), in Step S35, the user status recognizer 6 judges whether the third duration measured by the third timer is shorter than 1.2 seconds. If it is judged that the measured third duration is shorter than 1.2 seconds (YES in Step S35), in Step S36, the user status recognizer 6 integrates the number of times stored in the RAM to “1”. The user status recognizer 6 integrates the number of times by which the duration when the user 21 gazed at the display section 13 is shorter than 1.2 seconds, and stores the integration result in the RAM. The area in the RAM where the integrated value of the number of times is stored is different from the area in the RAM where the integrated value of the first duration and the integrated value of the second duration are stored. In view of this, the integrated value of the first duration, the integrated value of the second duration, and the integrated value of the number of times are individually stored.

In the case where it is judged that the number of times is integrated to “1”, or the measured third duration is not shorter than 1.2 seconds (NO in Step S35), in Step S37, the user status recognizer 6 terminates the measuring operation by the third timer, and sets the timer value of the third timer to “0”. In the case where the third timer does not measure a duration, in other words, the third duration is 0, the user status recognizer 6 judges that the third duration is not shorter than 1.2 seconds.

The operation in Step S37 is an operation to be performed in the case where the third timer measures the third duration. Specifically, the operation in Step S37 is performed in the case where the user's line of sight is not aligned with the direction of the display section 13 during a measuring operation of the third duration. In the case where a measuring operation is not performed by the third timer, the routine goes to Step S6 in FIG. 5 by skipping Step S37.

In the following, an operation to be performed after Step S6 in FIG. 5 is described. In Step S6, the user status recognizer 6 judges whether a predetermined period has elapsed since the camera 15 started acquiring photographic image data. In this embodiment, for instance, a timer incorporated in the controlling section 11 measures a predetermined period e.g. three minutes.

In this embodiment, the user status recognizer 6 judges whether a predetermined period has elapsed by measuring a duration. Alternatively, for instance, judgment may be made as to whether a predetermined period has elapsed, based on a timing of changing over an advice screen to be displayed on the display section 13 in each of the operating steps. In other words, a period from a point of time when a certain advice screen is displayed to a point of time when a next advice screen is displayed may be defined as the predetermined period. Further alternatively, judgment may be made as to whether a predetermined period has elapsed, based on the number of times of changing over the advice screen.

If it is judged that the predetermined period has not elapsed (NO in Step S6), the routine returns to Step S5. If, on the other hand, the predetermined period has elapsed (YES in Step S6), in Step S7, the user status recognizer 6 stores the integrated value of the first duration, the integrated value of the second duration, and the integrated value of the number of times stored in the RAM into the integrated value storage 7. The integrated value storage 7 stores the integrated values by the amount corresponding to at least three-times measuring operations. In other words, the integrated value storage 7 stores at least integrated values of the first duration, the second duration, and the number of times obtained by the second from the last measuring operation, integrated values of the first duration, the second duration, and the number of times obtained by the last measuring operation, and integrated values of the first duration, the second duration, and the number of times obtained by the current measuring operation.

Then, in Step S8, the user dependence estimator 8 executes a use dependence estimating operation of estimating the user's dependence degree on advice data, based on a user's reaction recognized by the user status recognizer 6. In this section, the user dependence estimating operation is described in detail.

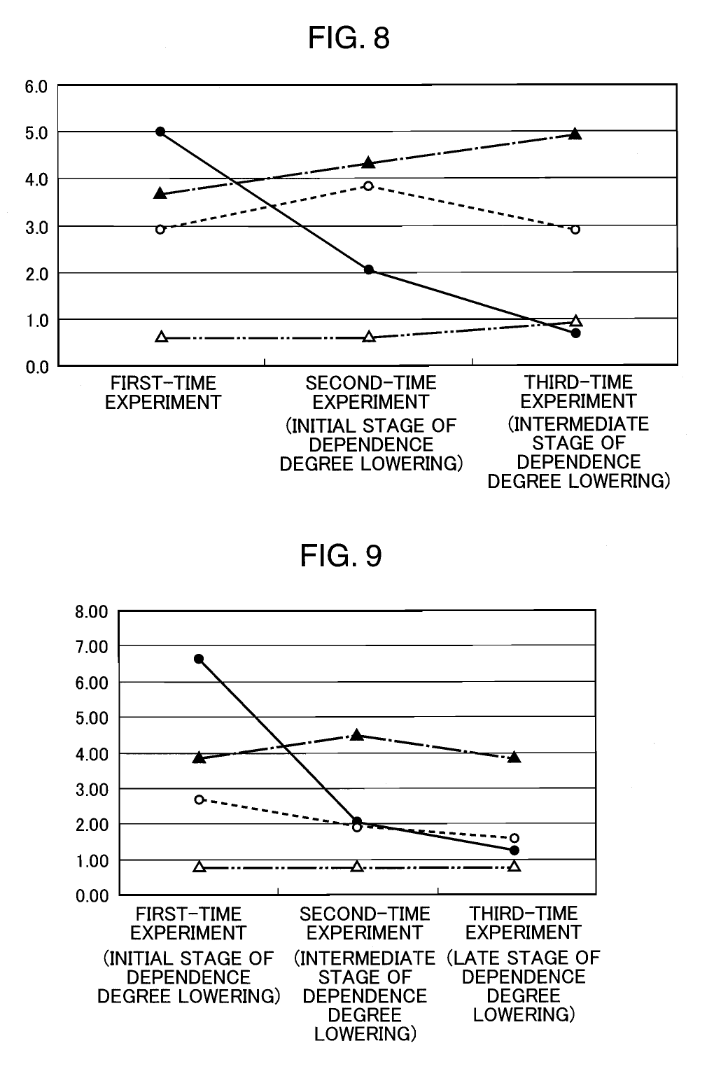

The inventors conducted an experiment of letting twenty subjects perform a mimicking cooking operation, while presenting advice data during the cooking operation to recognize movements of the user's face and line of sight. In the experiment, identical advice data was presented to all the twenty subjects. The experiment of letting the twenty subjects perform a mimicking cooking operation while presenting advice data was conducted three times in total. Throughout the three-times experiments, the identical advice data was presented. FIG. 8 is a graph showing experiment results, wherein the twenty subjects performed a mimicking cooking operation while being presented with advice data to recognize movements of the user's face and line of sight.

The inventors also conducted an experiment of letting eight subjects perform an actual cooking operation while presenting advice data during the cooking operation to recognize movements of the user's face and line of sight. The experiment was conducted three times in total. Throughout the experiments, identical advice data was presented. FIG. 9 is a graph showing experiment results, wherein the eight subjects performed an actual cooking operation while being presented with advice data to recognize movements of the user's face and line of sight.

The mimicking cooking operation shown in FIG. 8 is a cooking operation of manipulating cooking utensils on a cooking table in accordance with cooking steps, without actually handling food, heating food, and the like. Because the subjects performed a mimicking cooking operation, a time required for one-time cooking operation in FIG. 8 was about 5 minutes in average. On the other hand, in the experiment shown in FIG. 9, the subjects were made to cook hamburger steak. Because the subjects performed an actual cooking operation, a time required for one-time cooking operation in FIG. 9 was about 30 minutes in average.

In FIGS. 8 and 9, the horizontal axis indicates the number of experiments, and the vertical axis indicates movement of the user's face (unit: second), and movement of the user's line of sight (unit: number of times). The movement of the user's face is obtained by dividing the integrated duration by the number of subjects and the number of advices i.e. the number of presentations of advice screen. The movement of the user's line of sight is obtained by dividing the integrated value of the number of times by the number of subjects and the number of advices, and by dividing the dividend by four.

Referring to FIGS. 8 and 9, the line with solid black circles indicates an integrated value of a duration when the inclination angle θ of the user's face toward the display section 13 with respect to a condition that the user's face directs the work object 20 in forward direction is 30 degrees. The line with hollow circles indicates an integrated value of a duration when the inclination angle θ of the user's face toward the display section 13 with respect to the condition that the user's face directs the work object 20 in forward direction is 15 degrees or less. The line with solid black triangles indicates an integrated value of the number of times by which a duration when the user's line of sight is aligned with the direction of the display section 13 is shorter than 1.2 seconds. The line with hollow triangles indicates an integrated value of the number of times by which a duration when the user's line of sight is aligned with the direction of the display section 13 is not shorter than 1.2 seconds and not longer than 1.5 seconds.

As shown in FIGS. 8 and 9, the integrated value of the duration when the inclination angle θ is 30 degrees, in other words, the duration when the user's face directs the display section 13 in forward direction to look at an advice screen, is decreased, as the number of experiments is incremented; and the user's dependence degree is lowered, as the user's dependence degree lowering status progresses in three stages from an initial stage to an intermediate stage and to a late stage. The user's dependence degree is lowered in three stages from the initial stage to the intermediate stage and to the late stage. Also, the integrated value of the duration when the inclination angle θ is not larger than 15 degrees, in other words, the duration when the user's face has slightly inclined toward the display section 13, is temporarily increased until the user's dependence degree lowering status enters the initial stage, and then is decreased, as the dependence degree lowering status progresses from the initial stage to the intermediate stage and to the late stage.

The integrated value of the number of times by which the duration when the user's line of sight is aligned with the direction of the display section 13 is shorter than 1.2 seconds, in other words, the number of times when the user has glanced at the advice screen is increased, as the user's dependence degree lowering status progresses from the initial stage to the intermediate stage, and then is decreased, as the user's dependence degree lowering status progresses to the late stage. Also, the integrated value of the number of times by which the duration when the user's line of sight is aligned with the direction of the display section 13 is not shorter than 1.2 seconds and not longer than 1.5 seconds remains substantially unchanged, as the user's dependence degree lowering status progresses from the initial stage to the intermediate stage and to the late stage.

In the experiment result by the mimicking cooking operation shown in FIG. 8, the cooking operation was finished in a relatively short period. Accordingly, the number of times when the user 21 looked at the advice screen during the cooking operation was less, and the time when the user 21 looked at the advice screen was short. As a result, even in the second-time experiment, the user had to rely on advice data, and it can be concluded that the user's dependence degree has lowered in the initial stage corresponding to the second-time experiment. On the other hand, in the actual cooking operation shown in FIG. 9, a standby time was generated during a heating operation or a like operation. Accordingly, the number of times when the user 21 looked at the advice screen during the cooking operation was relatively large, and the time when the user 21 looked at the advice screen was relatively long. As a result, the user may have memorized the advice in the first-time experiment, and the user's dependence degree has started lowering even in the first-time experiment. Thus, it can be concluded that the user's dependence degree has lowered in the initial stage corresponding to the first-time experiment.

In the experiment result by the actual cooking operation shown in FIG. 9, a time is measured from the point of time when an advice screen is updated by a period corresponding to the period from the point of time when a certain advice screen is displayed to the point of time when the advice screen is updated in the mimicking cooking operation. Then, the movements of the user's face and line of sight during the measured time are recognized. The duration when the user's face directs the display section 13 in forward direction, the number of times by which a duration when the user's line of sight is aligned with the direction of the display section 13 is shorter than 1.2 seconds, and the number of times by which a duration when the user's line of sight is aligned with the direction of the display section 13 is not shorter than 1.2 seconds and not longer than 1.5 seconds are integrated, respectively. In this arrangement, a duration when the user 21 gazes at an advice screen during a standby period can be omitted in the actual cooking operation.

The following estimation on the user's dependence degree may be provided based on the above experiment results. Specifically, in the case where the duration when the user's face directs the display section 13 in forward direction is increased, it can be estimated that the user's dependence degree on advice data has increased. In the case where the duration when the user's face directs the display section 13 in forward direction is decreased, and the duration when the user's face is slightly inclined toward the display section 13 is increased, it can be estimated that the user's dependence degree lowering status is in the initial stage.

In the case where the duration when the user's face directs the display section 13 in forward direction is decreased, and the duration when user's face is slightly inclined toward the display section 13 is decreased, and the number of times when the user 21 glances at the advice screen is increased, it can be estimated that the user's dependence degree lowering status is in the intermediate stage. In the case where the number of times when the user 21 glances at the advice screen is temporarily increased, and then is decreased, it can be estimated that the user's dependence degree lowering status is in the late stage.

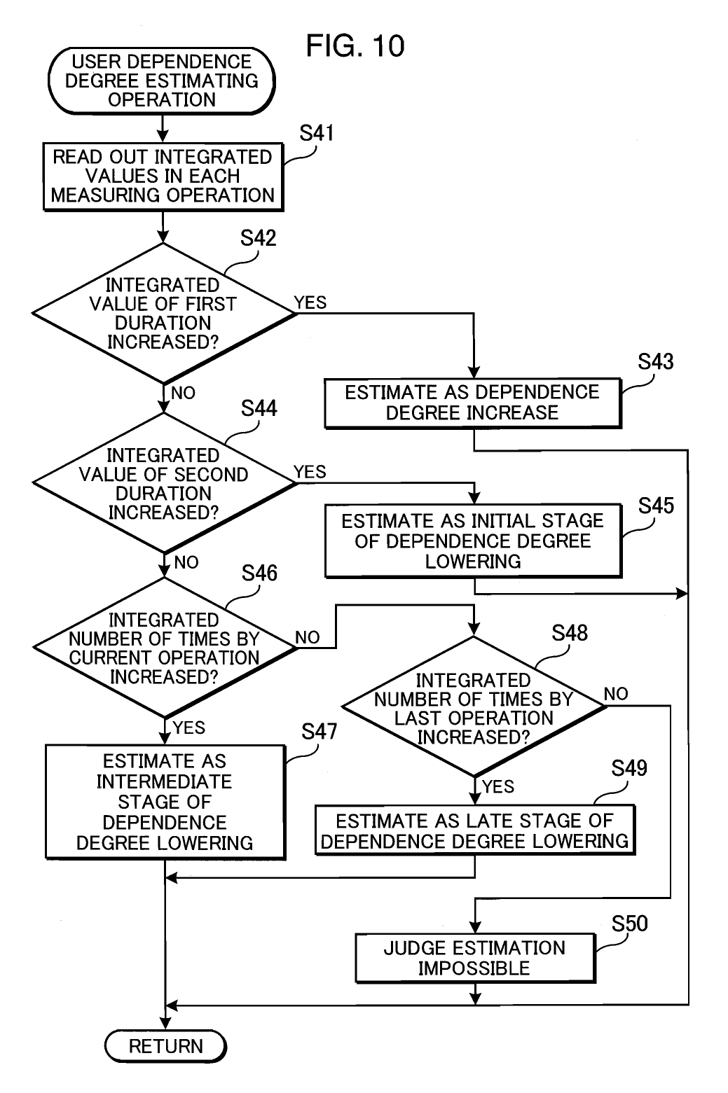

FIG. 10 is a flowchart for describing the user dependence estimating operation in Step S8 in FIG. 5.

When the user dependence estimating operation starts, in Step S41, the user dependence estimator 8 reads out, from the integrated value storage 7, the integrated value of the first duration, the integrated value of the second duration, and the integrated value of the number of times obtained by the current measuring operation, the integrated value of the first duration, the integrated value of the second duration, and the integrated value of the number of times obtained by the last measuring operation, and the integrated value of the number of times obtained by the second from the last measuring operation.

Then, in Step S42, the user dependence estimator 8 judges whether the integrated value of the first duration obtained by the current measuring operation is larger than the integrated value of the first duration obtained by the last measuring operation. In the case where it is judged that the integrated value of the first duration obtained by the current measuring operation is larger than the integrated value of the first duration obtained by the last measuring operation (YES in Step S42), in Step S43, the user dependence estimator 8 estimates that the user's dependence degree has increased.

If, on the other hand, it is judged that the integrated value of the first duration obtained by the current measuring operation is not larger than the integrated value of the first duration obtained by the last measuring operation (NO in Step S42), in Step S44, the user dependence estimator 8 judges whether the integrated value of the second duration obtained by the current measuring operation is larger than the integrated value of the second duration obtained by the last measuring operation. If it is judged that the integrated value of the second duration obtained by the current measuring operation is larger than the integrated value of the second duration obtained by the last measuring operation (YES in Step S44), in Step S45, the user dependence estimator 8 estimates that the user's dependence degree lowering status is in the initial stage.

If, on the other hand, it is judged that the integrated value of the second duration obtained by the current measuring operation is not larger than the integrated value of the second duration obtained by the last measuring operation (NO in Step S44), in Step S46, the user dependence estimator 8 judges whether the integrated value of the number of times obtained by the current measuring operation is larger than the integrated value of the number of times obtained by the last measuring operation. If it is judged that the integrated value of the number of times obtained by the current measuring operation is larger than the integrated value of the number of times obtained by the last measuring operation (YES in Step S46), in Step S47, the user dependence estimator 8 estimates that the user's dependence degree lowering status is in the intermediate stage.

If, on the other hand, it is judged that the integrated value of the number of times obtained by the current measuring operation is not larger than the integrated value of the number of times obtained by the last measuring operation (NO in Step S46), in Step S48, the user dependence estimator 8 judges whether the integrated value of the number of times obtained by the last measuring operation is larger than the integrated value of the number of times obtained by the second from the last measuring operation. If it is judged that the integrated value of the number of times obtained by the last measuring operation is larger than the integrated value of the number of times obtained by the second from the last measuring operation (YES in Step S48), in Step S49, the user dependence estimator 8 estimates that the user's dependence degree lowering status is in the late stage.

If, on the other hand, it is judged that the integrated value of the number of times obtained by the last measuring operation is not larger than the integrated value of the number of times obtained by the second from the last measuring operation (NO in Step S48), in Step S50, the user dependence estimator 8 judges that it is impossible to estimate the user's dependence degree. The estimation results on the user's dependence degree are temporarily stored in the RAM. In the case where the RAM stores merely the integrated values corresponding to one-time measuring operation, and it is impossible to judge whether the integrated values are increased, the user dependence estimator 8 judges that estimation is impossible.

Referring back to FIG. 5, in Step S9, the user dependence estimator 8 judges whether the user's work has been completed. If it is judged that the user's work has been completed (YES in Step S9), the work support operation is terminated. If, on the other hand, it is judged that the user's work has not been completed (NO in Step S9), the routine returns to Step S3 to execute an advice data selecting operation.

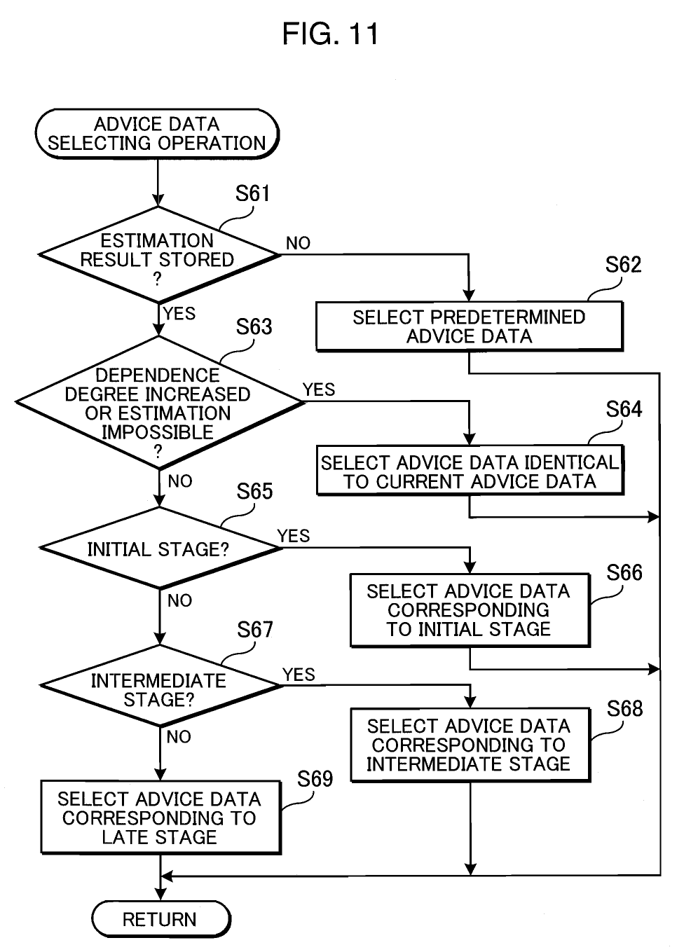

In the following, details of the advice data selecting operation is described. FIG. 11 is a flowchart for describing the advice data selecting operation in Step S3 in FIG. 5.

When the advice data selecting operation starts, in Step S61, the advice selector 4 judges whether there exists an estimation result on the user's dependence degree. As described above, since the estimation result on the user's dependence degree is temporarily stored in the RAM, the advice selector 4 judges whether the estimation result on the user's dependence degree is stored in the RAM. This enables to judge whether there exists an estimation result on the user's dependence degree. If it is judged that no estimation result on the user's dependence degree is stored in the RAM (NO in Step S61), in Step S62, the advice selector 4 selects predetermined advice data from the advice database 3. For instance, the advice selector 4 selects advice data corresponding to a lowest skill level.

If, on the other hand, it is judged that an estimation result on the user's dependence degree is stored in the RAM (YES in Step S61), in Step S63, the advice selector 4 judges whether the user's dependence degree has increased, or estimation is impossible. If it is judged that the user's dependence degree has increased, or estimation is impossible (YES in Step S63), in Step S64, the advice selector 4 selects advice data identical to the currently presented advice data.

If, on the other hand, it is judged that the user's dependence degree has lowered (NO in Step S63), in Step S65, the advice selector 4 judges whether the user's dependence degree lowering status is in the initial stage. If it is judged that the user's dependence degree lowering status is in the initial stage (YES in Step S65), in Step S66, the advice selector 4 selects advice data corresponding to the initial stage of the user's dependence degree lowering.

If, on the other hand, it is judged that the user's dependence degree lowering status is not in the initial stage (NO in Step S65), in Step S67, the advice selector 4 judges whether the user's dependence degree lowering status is in the intermediate stage. If it is judged that the user's dependence degree lowering status is in the intermediate stage (YES in Step S67), in Step S68, the advice selector 4 selects advice data corresponding to the intermediate stage of the user' dependence degree lowering.

If, on the other hand, it is judged that the user's dependence degree lowering status is not in the intermediate stage (NO in Step S67), in Step S69, the advice selector 4 selects advice data corresponding to the late stage of the user's dependence degree lowering.

As described above, the user's dependence degree on the currently presented advice data is estimated, and the advice data corresponding to the estimated user's dependence degree is selected from the advice database 3. This enables to present the user in performing a work with a proper advice.

The work support device of the embodiment is a work support device for supporting a user in performing a cooking operation. Alternatively, the work support device may be a navigation device adapted to support a user in performing a driving operation by guiding a driver driving an automobile to a destination by way of a map and audio information.

The work support device 10 may be configured into a universal information processing device as a hardware device, which is provided with a central processing unit (CPU), a nonvolatile memory or a storage device recorded with a program or permanent data, a high-speed accessible volatile memory for storing temporary data, and an input/output section; and an advice program for cooperatively operating these hardware resources may be realized as a software component by pre-storing the advice program in the nonvolatile memory or the storage device. In the modification, a work support program may be distributed via a computer-readable recording medium such a magnetic disk or an optical disc, or a communications line such as the Internet, and a function for writing data may be provided in the nonvolatile memory or the storage device in advance to allow addition of a new function or updating of the function.

The aforementioned embodiment and/or modifications primarily include the inventions having the following arrangements.

A recognizing device according to an aspect of the invention comprises: an advice data storage for storing advice data for supporting a user in performing a work; an advice selector for selecting advice data for the work from the advice data storage; an advice presenter for presenting the user with the advice data selected by the advice selector; a user status recognizer for recognizing a reaction of the user to the advice data presented by the advice presenter; and a user dependence estimator for estimating a dependence degree of the user indicating how much the user relies on the advice data presented by the advice presenter, based on the user's reaction recognized by the user status recognizer, wherein the advice selector selects, from the advice data storage, the advice data in accordance with the user's dependence degree estimated by the user dependence estimator.

A recognition method according to another aspect of the invention comprises: an advice selecting step of selecting advice data for a work from an advice data storage for storing the advice data for supporting the user in performing the work; an advice presenting step of presenting the user with the advice data selected in the advice selecting step; a user status recognizing step of recognizing a reaction of the user to the advice data presented in the advice presenting step; and a user dependence estimating step of estimating a dependence degree of the user indicating how much the user relies on the advice data presented in the advice presenting step, based on the user's reaction recognized in the user status recognizing step, wherein, in the advice selecting step, the advice data in accordance with the user's dependence degree estimated in the user dependence estimating step is selected from the advice data storage.

A recognition program according to yet another aspect of the invention causes a computer to function as: an advice data storage for storing advice data for supporting a user in performing a work; an advice selector for selecting advice data for the work from the advice data storage; an advice presenter for presenting the user with the advice data selected by the advice selector; a user status recognizer for recognizing a reaction of the user to the advice data presented by the advice presenter; and a user dependence estimator for estimating a dependence degree of the user indicating how much the user relies on the advice data presented by the advice presenter, based on the user's reaction recognized by the user status recognizer, wherein the advice selector selects, from the advice data storage, the advice data in accordance with the user's dependence degree estimated by the user dependence estimator.

A computer-readable recording medium recorded with a recognition program according to still another aspect of the invention causes a computer to function as: an advice data storage for storing advice data for supporting a user in performing a work; an advice selector for selecting advice data for the work from the advice data storage; an advice presenter for presenting the user with the advice data selected by the advice selector; a user status recognizer for recognizing a reaction of the user to the advice data presented by the advice presenter; and a user dependence estimator for estimating a dependence degree of the user indicating how much the user relies on the advice data presented by the advice presenter, based on the user's reaction recognized by the user status recognizer, wherein the advice selector selects, from the advice data storage, the advice data in accordance with the user's dependence degree estimated by the user dependence estimator.

In the above arrangements, the user's dependence degree indicating how much the user relies on the currently presented advice data is estimated, and the advice data in accordance with the estimated user's dependence degree is selected from the advice data storage. This enables to present the user in performing the work with a proper advice.

In the recognition device, preferably, the user status recognizer may recognize a change of the body of the user with time to the advice data presented by the advice presenter, and the user dependence estimator may estimate the user's dependence degree, based on the change of the user's body with time recognized by the user status recognizer.

The above arrangement enables to estimate the user's dependence degree indicating how much the user relies on the currently presented advice data, based on the user's body reaction with time to the presented advice data.

In the recognition device, preferably, the user status recognizer may recognize at least one of a movement of the face of the user and a movement of a line of sight of the user. In the above arrangement, at least one of the movement of the user's face and the movement of the user's line of sight is recognized. This enables to estimate the user's dependence degree on the currently presented advice data, based on the at least one of the movement of the user's face and the movement of the user's line of sight.

Preferably, the recognition device may further comprise a camera for capturing an image of the user, and a display section disposed in a substantially identical direction as the camera, wherein the advice presenter displays the advice data selected by the advice selector on the display section, the user status recognizer recognizes the movement of the user's face based on the image captured by the camera to integrate a duration when the user's face is inclined toward the display section with respect to a condition that the user's face directs a work object in forward direction, and recognizes the movement of the user's line of sight based on the image captured by the camera to integrate the number of times by which a duration when the user's line of sight is substantially aligned with the direction of the display section is shorter than a predetermined duration, and the user dependence estimator estimates whether the user's dependence degree on the currently presented advice data has increased or decreased, based on the duration and the number of times integrated by the user status recognizer.

In the above arrangement, the selected advice data is displayed on the display section. Then, the movement of the user's face is recognized based on the image captured by the camera to integrate the duration when the user's face is inclined toward the display section with respect to the condition that the user's face directs the work object in forward direction. Also, the movement of the user's line of sight is recognized based on the image captured by the camera to integrate the number of times by which the duration when the user's line of sight is substantially aligned with the direction of the display section is shorter than the predetermined duration. Subsequently, whether the user's dependence degree on the currently presented advice data has increased or decreased is estimated, based on the integrated duration and the integrated number of times.

The above arrangement enables to easily estimate whether the user's dependence degree on the currently presented advice data has increased or decreased, based on the integrated value of the duration when the user's face is inclined toward the display section with respect to the condition that the user's face directs the work object in forward direction, and the integrated value of the number of times by which the duration when the user's line of sight is substantially aligned with the direction of the display section is shorter than the predetermined duration.

In the recognition device, preferably, the advice data storage may store multiple advice data in correlation to a proficiency of the user with respect to the work, and the advice selector may select, from the advice data storage, the advice data correlated to a proficiency higher than the proficiency corresponding to the currently presented advice data, if the user dependence estimator estimates that the user's dependence degree on the currently presented advice data has lowered.

In the above arrangement, the advice data storage stores the multiple advice data in correlation to the proficiency of the user with respect to the work. In the case where it is estimated that the user's dependence degree on the currently presented advice data has lowered, the advice data correlated to the proficiency higher than the proficiency corresponding to the currently presented advice data is selected from the advice data storage.

In the above arrangement, the advice data correlated to the proficiency higher than the proficiency corresponding to the currently presented advice data is presented, even if the user's dependence degree on the currently presented advice data has lowered. This enables to increase the user's dependence degree on advice data.

In the recognition device, preferably, the user status recognizer may recognize a movement of the face of the user based on an image captured by a camera to integrate a first duration when the user's face directs the display section in forward direction, and integrate a second duration when the user's face is inclined toward the display section with respect to a condition that the user's face directs a work object in forward direction by an angle smaller than an angle defined by a direction in which the user's face directs the work object in forward direction and a direction in which the user's face directs the display section in forward direction; and a movement of a line of sight of the user based on the image captured by the camera to integrate the number of times by which a duration when the user's line of sight is substantially aligned with a direction of the display section is shorter than a predetermined duration, and the user dependence estimator may estimate the following: the user's dependence degree has increased, if an integrated value of the first duration obtained in a predetermined current measuring period is larger than an integrated value of the first duration obtained in a predetermined last measuring period; the user's dependence degree has lowered to a first stage, if the integrated value of the first duration obtained in the predetermined current measuring period is not larger than the integrated value of the first duration obtained in the predetermined last measuring period, and if an integrated value of the second duration obtained in the predetermined current measuring period is larger than an integrated value of the second duration obtained in the predetermined last measuring period; the user's dependence degree has lowered to a second stage lower than the first stage, if the integrated value of the first duration obtained in the predetermined current measuring period is not larger than the integrated value of the first duration obtained in the predetermined last measuring period, and if the integrated value of the second duration obtained in the predetermined current measuring period is not larger than the integrated value of the second duration obtained in the predetermined last measuring period, and if an integrated value of the number of times obtained in the predetermined current measuring period is larger than an integrated value of the number of times obtained in the predetermined last measuring period; and the user's dependence degree has lowered to a third stage lower than the second stage, if the integrated value of the number of times obtained in the predetermined last measuring period is larger than an integrated value of the number of times obtained in a predetermined second from the last measuring period, and if the integrated value of the number of times obtained in the predetermined current measuring period is not larger than the integrated value of the number of times obtained in the predetermined last measuring period.

In the above arrangement, the movement of the user's face is recognized based on the image captured by the camera to integrate the first duration when the user's face directs the display section in forward direction, and integrate the second duration when the user's face is inclined toward the display section with respect to the condition that the user's face directs the work object in forward direction by the angle smaller than the angle defined by the direction in which the user's face directs the work object in forward direction and the direction in which the user's face directs the display section in forward direction. Also, the movement of the user's line of sight is recognized based on the image captured by the camera to integrate the number of times by which the duration when the user's line of sight is substantially aligned with the direction of the display section is shorter than the predetermined duration. It is estimated that the user's dependence degree has increased, if the integrated value of the first duration obtained in the predetermined current measuring period is larger than the integrated value of the first duration obtained in the predetermined last measuring period. It is estimated that the user's dependence degree has lowered to the first stage, if the integrated value of the first duration obtained in the predetermined current measuring period is not larger than the integrated value of the first duration obtained in the predetermined last measuring period, and if the integrated value of the second duration obtained in the predetermined current measuring period is larger than the integrated value of the second duration obtained in the predetermined last measuring period. It is estimated that the user's dependence degree has lowered to the second stage lower than the first stage, if the integrated value of the first duration obtained in the predetermined current measuring period is not larger than the integrated value of the first duration obtained in the predetermined last measuring period, and if the integrated value of the second duration obtained in the predetermined current measuring period is not larger than the integrated value of the second duration obtained in the predetermined last measuring period, and if the integrated value of the number of times obtained in the predetermined current measuring period is larger than the integrated value of the number of times obtained in the predetermined last measuring period. It is estimated that the user's dependence degree has lowered to the third stage lower than the second stage, if the integrated value of the number of times obtained in the predetermined last measuring period is larger than the integrated value of the number of times obtained in the predetermined second from the last measuring period, and if the integrated value of the number of times obtained in the predetermined current measuring period is not larger than the integrated value of the number of times obtained in the predetermined last measuring period.

The above arrangement enables to stepwise estimate the user's dependence degree, based on the integrated value of the first duration when the user's face directs the display section in forward direction; the integrated value of the second duration when the user's face is inclined toward the display section with respect to the condition that the user's face directs the work object in forward direction by the angle smaller than the angle defined by the direction in which the user's face directs the work object in forward direction and the direction in which the user's face directs the display section in forward direction; and the integrated value of the number of times by which the duration when the user's line of sight is substantially aligned with the direction of the display section is shorter than the predetermined duration.

In the recognition device, preferably, the advice data storage may store the advice data in accordance with the first stage, the second stage, and the third stage, and the advice selector may select the advice data in accordance with the first stage from the advice data storage, if the user dependence estimator estimates that the user's dependence degree has lowered to the first stage, select the advice data in accordance with the second stage from the advice data storage, if the user dependence estimator estimates that the user's dependence degree has lowered to the second stage, and select the advice data in accordance with the third stage from the advice data storage, if the user dependence estimator estimates that the user's dependence degree has lowered to the third stage.

In the above arrangement, the advice data storage stores the advice data in accordance with each of the first stage, the second stage, and the third stage. The advice data in accordance with the first stage is selected from the advice data storage, if it is estimated that the user's dependence degree has lowered to the first stage. The advice data in accordance with the second stage is selected from the advice data storage, if it is estimated that the user's dependence degree has lowered to the second stage. The advice data in accordance with the third stage is selected from the advice data storage, if it is estimated that the user's dependence degree has lowered to the third stage.

In the above arrangement, since the advice data in accordance with the stepwise user's dependence degree is presented, even if the user's dependence degree on the currently presented advice data has lowered, the user's dependence degree on advice data can be increased.

Preferably, in the recognition device, preferably, the user status recognizer may recognize the movement of the user's line of sight based on the image captured by the camera to integrate the number of times by which the duration when the user's line of sight is substantially aligned with the direction of the display section is not longer than 1.5 seconds.

In the above arrangement, the number of times when the user has glanced at the advice data displayed on the display section for a short time to check the advice data can be integrated by integrating the number of times by which the duration when the user's line of sight is substantially aligned with the direction of the display section is not longer than 1.5 seconds. Also, the user's dependence degree can be estimated by using the integrated value of the number of times.

Reportedly, it is impossible to determine whether the user has a keen interest in the object, in the case where the line-of-sight stay duration in a certain area is shorter than 1.2 seconds. In view of the above, it is more preferable to integrate the number of times by which the duration when the user's line of sight is substantially aligned with the direction of the display section is shorter than 1.2 seconds. This enables to integrate the number of times when the user has glanced at the advice data displayed on the display section for a short time to check the advice data.

Preferably, the recognition device may further comprise a work contents acceptor for accepting selection of a work contents for which the user wishes to obtain an advice from a number of work contents, and the advice selector may select the advice data in accordance with the work contents accepted by the work contents acceptor from the advice data storage.

In the above arrangement, selection of the work contents for which the user wishes to obtain an advice is accepted from the number of work contents. Then, the advice data in accordance with the accepted work contents is selected from the advice data storage. This enables to present the user with the advice data in accordance with the work contents.

In the recognition device, preferably, the advice data storage may store the advice data for supporting the user in performing a cooking operation. In this arrangement, since the advice data for supporting the user in performing the cooking operation is stored, the advice for supporting the user in performing the cooking operation can be provided to the user.

In the recognition device, preferably, the advice data storage may store the advice data for supporting the user in driving an automobile. In this arrangement, since the advice data for supporting the user in driving the automobile is stored, the advice for supporting the user in driving the automobile can be provided to the user.

The recognition device, the recognition method, and the computer-readable recording medium recorded with the recognition program of the invention enable to estimate the user's dependence degree on a presented advice, and provide the user with an appropriate advice in accordance with the estimated user's dependence degree. Thus, the invention is useful as a recognition device, a recognition method, and a computer-readable recording medium recorded with the recognition program for presenting a user with an advice for supporting the user in performing a work by way of a moving image, a sound, or a like tool.

This application is based on Japanese Patent Application No. 2007-088654 filed on Mar. 29, 2007, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A recognition device, comprising:
an advice data storage for storing advice data for supporting a user in performing a work;
an advice selector for selecting advice data for the work from the advice data storage;
an advice presenter for presenting the user with the advice data selected by the advice selector;
a user status recognizer for recognizing a reaction of the user to the advice data presented by the advice presenter; and
a user dependence estimator for estimating a dependence degree of the user indicating how much the user relies on the advice data presented by the advice presenter, based on the user's reaction recognized by the user status recognizer, wherein
the advice selector selects, from the advice data storage, the advice data in accordance with the user's dependence degree estimated by the user dependence estimator.

2. The recognition device according to claim 1, wherein
the user status recognizer recognizes a change of the body of the user with time to the advice data presented by the advice presenter, and
the user dependence estimator estimates the user's dependence degree, based on the change of the user's body with time recognized by the user status recognizer.

3. The recognition device according to claim 2, wherein
the user status recognizer recognizes at least one of a movement of the face of the user and a movement of a line of sight of the user.

4. The recognition device according to claim 3, further comprising:
a camera for capturing an image of the user; and
a display section disposed in a substantially identical direction as the camera, wherein
the advice presenter displays the advice data selected by the advice selector on the display section,
the user status recognizer recognizes the movement of the user's face based on the image captured by the camera to integrate a duration when the user's face is inclined toward the display section with respect to a condition that the user's face directs a work object in forward direction, and recognizes the movement of the user's line of sight based on the image captured by the camera to integrate the number of times by which a duration when the user's line of sight is substantially aligned with the direction of the display section is shorter than a predetermined duration, and
the user dependence estimator estimates whether the user's dependence degree on the currently presented advice data has increased or decreased, based on the duration and the number of times integrated by the user status recognizer.

5. The recognition device according to claim 4, wherein
the advice data storage stores multiple advice data in correlation to a proficiency of the user with respect to the work, and
the advice selector selects, from the advice data storage, the advice data correlated to a proficiency higher than the proficiency corresponding to the currently presented advice data, if the user dependence estimator estimates that the user's dependence degree on the currently presented advice data has lowered.

6. The recognition device according to claim 4, wherein
the user status recognizer recognizes a movement of the face of the user based on an image captured by the camera to integrate a first duration when the user's face directs the display section in forward direction, and integrate a second duration when the user's face is inclined toward the display section with respect to a condition that the user's face directs a work object in forward direction by an angle smaller than an angle defined by a direction in which the user's face directs the work object in forward direction and a direction in which the user's face directs the display section in forward direction; and a movement of a line of sight of the user based on the image captured by the camera to integrate the number of times by which a duration when the user's line of sight is substantially aligned with a direction of the display section is shorter than a predetermined duration, and
the user dependence estimator estimates the following:
the user's dependence degree has increased, if an integrated value of the first duration obtained in a predetermined current measuring period is larger than an integrated value of the first duration obtained in a predetermined last measuring period;
the user's dependence degree has lowered to a first stage, if the integrated value of the first duration obtained in the predetermined current measuring period is not larger than the integrated value of the first duration obtained in the predetermined last measuring period, and if an integrated value of the second duration obtained in the predetermined current measuring period is larger than an integrated value of the second duration obtained in the predetermined last measuring period;
the user's dependence degree has lowered to a second stage lower than the first stage, if the integrated value of the first duration obtained in the predetermined current measuring period is not larger than the integrated value of the first duration obtained in the predetermined last measuring period, and if the integrated value of the second duration obtained in the predetermined current measuring period is not larger than the integrated value of the second duration obtained in the predetermined last measuring period, and if an integrated value of the number of times obtained in the predetermined current measuring period is larger than an integrated value of the number of times obtained in the predetermined last measuring period; and
the user's dependence degree has lowered to a third stage lower than the second stage, if the integrated value of the number of times obtained in the predetermined last measuring period is larger than an integrated value of the number of times obtained in a predetermined second from the last measuring period, and if the integrated value of the number of times obtained in the predetermined current measuring period is not larger than the integrated value of the number of times obtained in the predetermined last measuring period.

7. The recognition device according to claim 6, wherein
the advice data storage stores the advice data in accordance with the first stage, the second stage, and the third stage, and
the advice selector selects the advice data in accordance with the first stage from the advice data storage, if the user dependence estimator estimates that the user's dependence degree has lowered to the first stage, selects the advice data in accordance with the second stage from the advice data storage, if the user dependence estimator estimates that the user's dependence degree has lowered to the second stage, and selects the advice data in accordance with the third stage from the advice data storage, if the user dependence estimator estimates that the user's dependence degree has lowered to the third stage.

8. The recognition device according to claim 6, wherein
the user status recognizer recognizes the movement of the user's line of sight based on the image captured by the camera to integrate the number of times by which the duration when the user's line of sight is substantially aligned with the direction of the display section is not longer than 1.5 seconds.

9. The recognition device according to claim 1, further comprising:
a work contents acceptor for accepting selection of a work contents for which the user wishes to obtain an advice from a number of work contents, and
the advice selector selects the advice data in accordance with the work contents accepted by the work contents acceptor from the advice data storage.

10. The recognition device according to claim 1, wherein
the advice data storage stores the advice data for supporting the user in performing a cooking operation.

11. The recognition device according to claim 1, wherein
the advice data storage stores the advice data for supporting the user in driving an automobile.

12. A recognition method, comprising:
an advice selecting step of selecting advice data for a work from an advice data storage for storing the advice data for supporting the user in performing the work;
an advice presenting step of presenting the user with the advice data selected in the advice selecting step;
a user status recognizing step of recognizing a reaction of the user to the advice data presented in the advice presenting step; and
a user dependence estimating step of estimating a dependence degree of the user indicating how much the user relies on the advice data presented in the advice presenting step, based on the user's reaction recognized in the user status recognizing step, wherein
in the advice selecting step, the advice data in accordance with the user's dependence degree estimated in the user dependence estimating step is selected from the advice data storage.

13. A computer-readable recording medium recorded with a recognition program for causing a computer to function as:
an advice data storage for storing advice data for supporting a user in performing a work;
an advice selector for selecting advice data for the work from the advice data storage;
an advice presenter for presenting the user with the advice data selected by the advice selector;
a user status recognizer for recognizing a reaction of the user to the advice data presented by the advice presenter; and
a user dependence estimator for estimating a dependence degree of the user indicating how much the user relies on the advice data presented by the advice presenter, based on the user's reaction recognized by the user status recognizer, wherein
the advice selector selects, from the advice data storage, the advice data in accordance with the user's dependence degree estimated by the user dependence estimator.
